(19) United States
(12) Patent Application Publication
(10) Pub. No.: US 2020/0333937 A1
(43) Pub. Date: Oct. 22, 2020

(54) INPUT DEVICE

(71) Applicant: Alps Alpine Co., Ltd., Tokyo (JP)

(72) Inventors: Michiharu MOTONISHI, Tokyo (JP); Kiyoshi KOBAYASHI, Tokyo (JP); Yusuke KOIKE, Niigata-ken (JP)

(21) Appl. No.: 16/920,164

(22) Filed: Jul. 2, 2020

Related U.S. Application Data
(63) Continuation of application No. PCT/JP2018/048205, filed on Dec. 27, 2018.

(30) Foreign Application Priority Data
Jan. 22, 2018 (JP) 2018-007970

(51) Int. Cl. G06F 3/041; H01R 12/65; H01R 12/62

(52) U.S. Cl. CPC G06F 3/04164; G06F 3/044; H01R 12/62; H01R 12/65

(57) ABSTRACT

An input device includes a support base member, a sensor unit having a plurality of electrode units (first electrodes and second electrodes) provided on the support base member, an extension extending outward from the support base member, a lead wire provided along a first principal surface of the extension and electrically conductive with the plurality of electrode units, and a flexible wiring substrate having a connection terminal electrically conductive with the lead wire in a principal surface and disposed facing the first principal surface of the extension. The extension has a bend allowance section that allows bending between an extension end and a connection base connected to the support base member. The lead wire is electrically conductive with the connection terminal at the extension-end side of the extension relative to the bend allowance section. A cover is provided entirely over the lead wire located at the bend allowance section.

### CLAIM OF PRIORITY

This application is a Continuation of International Application No. PCT/JP2018/048205 filed on Dec. 27, 2018, which claims benefit of Japanese Patent Application No. 2018-007970 filed on Jan. 22, 2018. The entire contents of each application noted above are hereby incorporated by reference.

### BACKGROUND OF THE INVENTION

### 1. Field of the Invention

The present invention relates to input devices. In particular, the present invention relates to an input device equipped with a touch sensor that detects a position approached by, for example, a finger.

### 2. Description of the Related Art

Touchscreens widely used as input devices are equipped with touch sensors that detect positions approached by fingers in detection regions (the term “approach” includes contact hereinafter). For example, a mutual capacitance touchscreen is provided with a driving electrode and an output electrode and applies a drive pulse to the driving electrode and uses the output electrode to detect a change in capacitance caused by approaching of, for example, a finger.

In such a touchscreen, an extension extending outward from a support base member is provided at an edge of a panel for achieving electrical conduction with a detection electrode. The extension has a lead wire electrically conductive with an electrode in the detection region, and also has a grounding wire serving as a grounding potential. Moreover, the distal end of the extension is provided with a flexible wiring substrate for connecting with an external connector. Depending on the product in which the touchscreen is installed, it is necessary to connect the extension to the connector by routing the extension in a bent state from the touchscreen. When the extension is bent in this manner, problems, such as a crack or a breakage, may possibly occur at the lead wire that is bent together with the extension.

International Publication No. WO 2017/195451 discloses an input device including a translucent and flexible base member, a plurality of translucent first electrode units arranged in a first direction in a detection region on the base member, a plurality of translucent second electrode units arranged in a second direction intersecting the first direction in the detection region on the base member, and a plurality of lead wires electrically conductive with the plurality of first electrode units and the plurality of second electrode units and extending from the detection region on the base member to a peripheral region outside the detection region. The peripheral region of the base member is provided with a bent section. The lead wires each have a flexible conductive member provided on the bent section. A cover is provided to cover at least a part of the flexible conductive member provided on the bent section.

From a standpoint of reducing the resistance value of the lead wires, it is sometimes demanded that the lead wires located at the bent section not only be formed of the flexible conductive members described in Patent Literature 1 but also be composed of a material having conductivity equal to that of the material forming the routing pattern located on the support base member. In order to prepare for such a case, it is demanded that damage to the lead wires disposed at the bent section during use be further reduced.

### SUMMARY OF THE INVENTION

The present invention provides an input device that can suppress damage to a lead wire provided at an extension even in a case where the lead wire located at a bent section is composed of the same material as a routing pattern located on a base member.

In order to solve the aforementioned problem, an aspect of the present invention provides an input device including a support base member, a sensor unit provided on the support base member and having a plurality of electrode units, an extension extending outward from the support base member, a lead wire provided along a first principal surface of the extension and electrically conductive with the electrode units, and a flexible wiring substrate having a connection terminal electrically conductive with the lead wire in a principal surface and disposed facing the first principal surface of the extension. The extension has a bend allowance section that allows bending between an extension end and a connection base connected to the support base member. The lead wire is electrically conductive with the connection terminal at the extension-end side of the extension relative to the bend allowance section. A cover is provided entirely over the lead wire located at the bend allowance section.

According to such a configuration, even when the bend allowance section is partially or entirely bent, the cover is provided entirely on the lead wire (bend lead wire) located at the bend allowance section, so that even if the bend lead wire is not formed of a flexible conductive member but is composed of, for example, a metallic conductive material, a crack in the bend lead wire due to tensile stress caused by bending is suppressed.

The lead wire and the connection terminal are preferably joined in an electrically conductive manner by a conductive joining member, a joining member for forming the conductive joining member preferably extends over the bend allowance section, and a member based on the joining member preferably serves as at least a part of the cover. The material forming the cover is not limited so long as it can entirely cover the bend lead wire. So long as the member for forming the conductive joining member extends over the bend allowance section to serve as at least a part of the cover, the cover can appropriately cover the bend lead wire even if the bend allowance section of the extension starts from the end at the connection base side of the connection terminal of the flexible wiring substrate, whereby a crack in the bend lead wire can be suppressed. The conductive joining member can be obtained by causing an anisotropic conductive adhesive to cure in a pressurized state. By causing this anisotropic conductive adhesive to cure while, for example, reducing the degree of pressure applied thereto, a nonconductive cured product that may function as a cover can be obtained.

The flexible wiring substrate may have an extension substrate section extending toward the sensor unit relative to the connection terminal, and the extension substrate section may serve as a part of the cover. In the case where the flexible wiring substrate has the extension substrate section, the extension substrate section is located above the bend lead wire. As a result, the bend lead wire is interposed between the extension substrate section and the support base member, so that the bend lead wire, when bent, is located near a neutral plane in the thickness direction. Therefore, a strong tensile stress is less likely to occur at the bend lead wire when bent. Consequently, even when the degree of bending of the extension is large, the bend lead wire is less likely to crack.

The input device may further include a functional layer provided on the support base member. The functional layer may extend over the bend allowance section and serve as a part of the cover. One example of the aforementioned functional layer is a protection layer. A protection layer is sometimes provided for physically and chemically protecting the electrode units located on the support base member of the sensor unit and a routing pattern electrically conductive with the electrode units. If this protection layer extends to the bend allowance section of the extension, the bend lead wire is interposed between this protection layer and the support base member, so that the bend lead wire, when bent, is located near the neutral plane in the thickness direction, whereby a strong tensile stress is less likely to occur at the bend lead wire. Consequently, even when the degree of bending of the extension is large, the bend lead wire is less likely to crack. The aforementioned protection layer may have a single-layer structure, or may have a multilayer structure.

The functional layer may include an optical layer. A specific example of the optical layer is a polarizing plate.

In the input device described above, the lead wire located at the bend allowance section may have a meandering section that meanders, as viewed from a normal direction of the first principal surface. Even in a case where the extension is bent such that the extending direction thereof is aligned with the circumferential direction and that a tensile stress occurs at the surface where the bend lead wire is located, such a meandering section provided attenuates the tensile stress applied to the bend lead wire in accordance with the inclination of the meandering section relative to the extending direction of the extension. Consequently, even when the degree of bending of the extension is large, the bend lead wire is less likely to crack.

In the input device described above, the support base member and the extension may be composed of a translucent material containing a cycloolefin-based polymer. A polymer containing cycloolefin as at least a part of a monomer (such a polymer is also referred to as “cycloolefin-based polymer” in this specification), such as a cycloolefin polymer (COP) or a cycloolefin copolymer (COC), is preferable as a material forming the support base member and the extension from a standpoint of high optical isotropy and high heat resistance. However, a film that contains a cycloolefin-based polymer has low flexibility in contrast with, for example, a polyester-based film. Therefore, if a cover covering the bend lead wire is not provided, when a bending force is applied to the cycloolefin-based-polymer-containing film forming the extension, the neutral plane in the thickness direction would be located within the film forming the extension. Thus, an internal stress cannot be completely absorbed by expansion and contraction of the film-forming material located at the bent section, possibly causing a crack to form in the film forming the extension. When a crack forms in this film, a strong tensile stress occurs especially at the bend lead wire formed thereon. However, when a cover is provided on the bend lead wire, as described above, the bend lead wire is interposed between the extension and the cover, so that the bend lead wire is located near the neutral plane in the thickness direction. Therefore, even when the bend allowance section is bent, a possibility in which a strong tensile stress occurs at the bend lead wire is reduced. Moreover, it is also possible that the neutral plane be not located within the film forming the extension. In this case, a stress variation in the thickness direction of the film is reduced, so that even when the film forming the extension contains a cycloolefin-based polymer, a crack is less likely to occur in the extension at the bent section.

In the input device described above, the plurality of electrode units and the lead wire may be electrically connected by a routing pattern provided on the support base member, and the lead wire located at the bend allowance section may be composed of a material forming the routing pattern. With the material for forming the routing pattern being identical to the material forming the bend lead wire, the wiring resistance between the plurality of electrode units located at the sensor unit and the connection terminal of the flexible wiring substrate can be readily reduced.

In the support base member of the input device described above, a second base principal surface located opposite a first base principal surface located at the same side as the first principal surface of the extension is preferably located at an operation-surface side of the input device. In the case of such a configuration, bending is normally performed such that the extension is located at the outer side during use, whereas the bend lead wire provided at the first principal surface thereof is located at the inner side. In the case of such bending, a tensile stress is less likely to occur at the bent lead wire, so that a crack is less likely to form in the lead wire. A case where the input device further includes a panel disposed facing the second base principal surface is preferable since there is a higher possibility that the input device is used in the bent state described above (the bent state where the bend lead wire is located at the inner side relative to the extension).

Provided is an input device that can suppress damage to a lead wire provided at an extension even in a case where the lead wire located at a bent section is composed of the same material as a routing pattern located on a base member.

### BRIEF DESCRIPTION OF THE DRAWINGS

FIG. 1 is an exploded perspective view illustrating an interface apparatus to which an input device according to a first embodiment of the present invention is applied;

FIG. 2A is a cross-sectional view taken along line IIA-IIA in FIG. 1, FIG. 2B is an enlarged partial cross-sectional view of a bent section and the vicinity thereof in FIG. 2A, and FIG. 2C is an enlarged cross-sectional view of an extension, in a yet-to-be bent state, and components attached thereto in the input device shown in FIG. 2B;

FIG. 3A is a partial cross-sectional view illustrating the state of a bent section of an input device according to the related art, and FIG. 3B is a partial cross-sectional view illustrating the state of the bent section of the input device according to the first embodiment;

FIG. 4A illustrates the configuration of an extension and so on according to another example of the input device according to the first embodiment, FIG. 4B illustrates the configuration of an extension and so on according to yet another example of the input device according to the first embodiment, FIG. 4C illustrates the configuration of a modification of the extension and so on shown in FIG. 4B, and FIG. 4D illustrates the configuration of an extension and so on according to yet another example of the input device according to the first embodiment;

FIG. 5 is an exploded perspective view illustrating an interface apparatus to which an input device according to a second embodiment of the present invention is applied;

FIG. 6A is a cross-sectional view taken along line VIA-VIA in FIG. 1, FIG. 6B is an enlarged partial cross-sectional view of a bent section and the vicinity thereof in FIG. 6A, and FIG. 6C is a partial cross-sectional view illustrating the state of the bent section of the input device according to the second embodiment;

FIG. 7 illustrates the configuration of an extension and so on according to an input device according to a third embodiment of the present invention; and

FIG. 8 schematically illustrates an application example of the input device.

### DESCRIPTION OF THE PREFERRED EMBODIMENTS

Embodiments of the present invention will be described below with reference to the drawings. In the following description, identical components are given the same reference signs, and descriptions of components already described once will be omitted, where appropriate.

Interface Apparatus to which Input Device is Applied

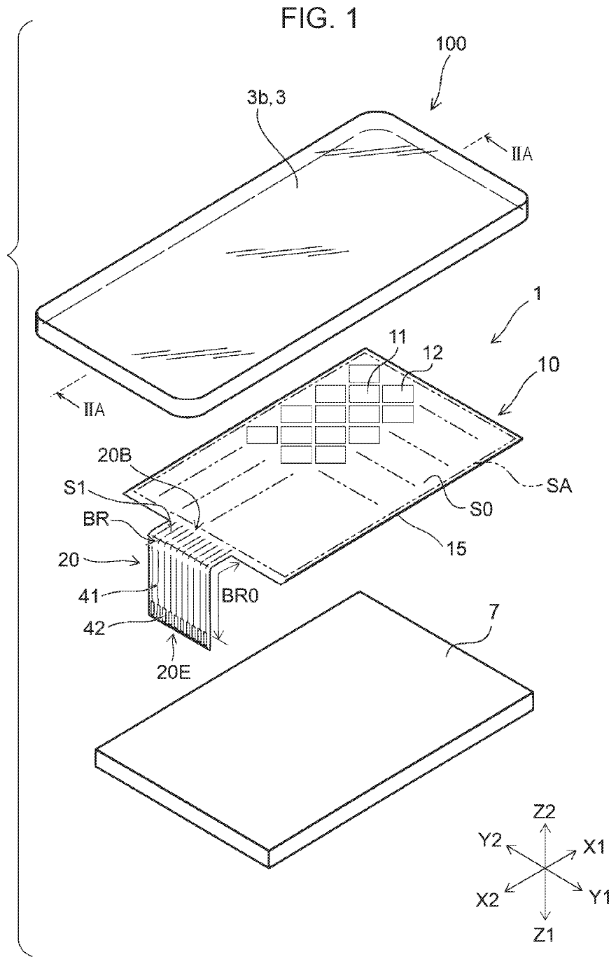

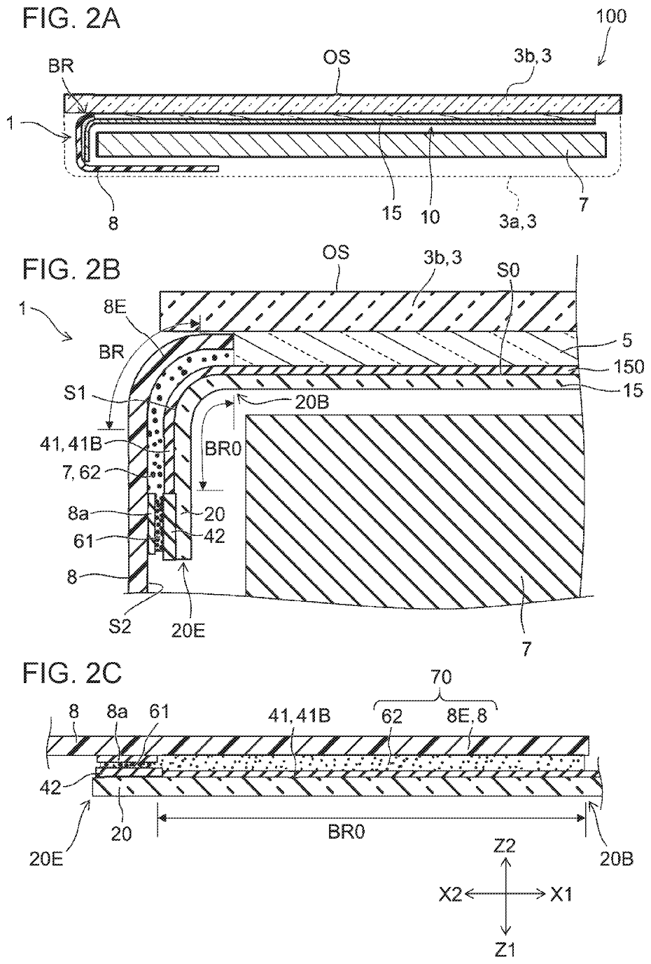

FIG. 1 is an exploded perspective view illustrating an interface apparatus 100 to which an input device 1 according to a first embodiment of the present invention is applied. FIG. 2A is a cross-sectional view taken along line IIA-IIA in FIG. 1. FIG. 2B is an enlarged partial cross-sectional view of a bent section BR and the vicinity thereof in FIG. 2A. FIG. 2C is an enlarged cross-sectional view of an extension 20, in a yet-to-be bent state, and components attached thereto in the input device 1 shown in FIG. 2B. In FIG. 2C, a transparent adhesive layer 5 and a panel 3b that are provided on a support base member 15 are not shown.

As shown in FIG. 1 and FIGS. 2A to 2C, the interface apparatus 100 to which the input device 1 according to the first embodiment is applied has a housing 3. The housing 3 is constituted of a combination of a main casing 3a and the panel 3b. For the sake of convenience, the main casing 3a is indicated with a dashed line only in FIG. 2A. The main casing 3a is composed of, for example, a synthetic resin material. The main casing 3a has a shape of a box with an upper opening. The panel 3b is disposed to cover the opening of the main casing 3a. An outer surface (at the Z2 side in the Z1-Z2 direction) of the panel 3b serves as an operation surface OS of the interface apparatus 100.

The panel 3b is composed of glass or a translucent resin material, such as polycarbonate resin or acrylic resin. In this specification, the terms “translucent” and “transparent” refer to a state where the visible light transmittance is 50% or higher (preferably 80% or higher).

The input device 1 is disposed at the inner side of the panel 3b. The input device 1 includes the support base member 15, a sensor unit 10 having a plurality of electrode units (first electrodes 11 and second electrodes 12) provided on the support base member 15, the extension 20 extending outward (toward the X2 side in the X1-X2 direction) from the support base member 15, lead wires 41 provided along a first principal surface S1 of the extension 20 and electrically conductive with the plurality of electrode units (the first electrodes 11 and the second electrodes 12), and a flexible wiring substrate 8 that has a connection terminal 8a electrically conductive with the lead wires 41 at a principal surface (second principal surface S2) and that is disposed facing the first principal surface S1 of the extension 20. In FIG. 1, the flexible wiring substrate 8 is not shown.

The input device 1 is, for example, a touchscreen. The input device 1 may be attached on a display device 7, such as a liquid crystal display panel or an electroluminescence display panel, or may be attached on a decorative unit (not shown). The sensor unit 10 is, for example, a capacitance touch sensor and performs position detection in accordance with a change in capacitance occurring when a detection region SA is approached by, for example, a finger. The sensor unit 10 is disposed on the support base member 15, specifically, on the principal surface at the Z2 side in the Z1-Z2 direction (first base principal surface S0). The support base member 15 may be formed of a flexible film composed of a translucent material, including a polyester-based resin film, such as polyethylene terephthalate (PET), and a cycloolefin-based polymer film, such as a cycloolefin polymer (COP) or a cycloolefin copolymer (COC), or a plate composed of a translucent material, such as acrylic resin or polycarbonate resin. The support base member 15 is bonded to the inner surface of the panel 3b by the transparent adhesive layer 5 composed of a transparent adhesive, such as an optically clear adhesive (OCA).

The detection region SA in the support base member 15 is provided with the first electrodes 11 and the second electrodes 12 serving as translucent electrode units. The first electrodes 11 extend in one direction (e.g., X direction) along the surface of the support base member 15, and the second electrodes 12 extend in a direction (e.g., Y direction) orthogonal to the one direction along the surface of the support base member 15. The first electrodes 11 and the second electrodes 12 are insulated from each other. In this embodiment, a plurality of first electrodes 11 are arranged at a predetermined pitch in the Y direction, and a plurality of second electrodes 12 are arranged at a predetermined pitch in the X direction.

There are various electrode patterns constituting the first electrodes 11 and the second electrodes 12. In this embodiment, the first electrodes 11 and the second electrodes 12 individually have a plurality of island-like electrode units. For example, each island-like electrode unit has a rhomboidal-like shape. The first electrodes 11 and the second electrodes 12 are composed of a translucent conductive material (such as an indium tin oxide (ITO), SnO2, ZnO, a conductive nano material, or a metallic material with a mesh pattern).

A routing pattern 150 electrically conductive with the first electrodes 11 and the second electrodes 12 extends in a surrounding area at the outer side of the detection region SA of the support base member 15. As shown in FIG. 2B, the routing pattern 150 is electrically conductive with the lead wires 41, so as to extend the electrical conduction line for the first electrodes 11 and the second electrodes 12 from the surrounding area to the distal end of the extension 20.

The extension 20 extends outward (specifically, toward the X2 side in the X1-X2 direction) from an edge of the support base member 15, and may be integrated with the support base member 15 or may be connected as a separate component with the support base member 15. The extension 20 is formed of a film material having flexibility, including a polyester-based film, such as PET, or a film containing a cycloolefin-based polymer, such as COP or COC. In the input device 1 according to this embodiment, the extension 20 is integrated with the support base member 15, and the routing pattern 150 is provided at the first base principal surface S0 serving as the principal surface of the support base member 15 at the side where the first electrodes 11 and the second electrodes 12 are provided.

The first principal surface S1 of the extension 20 is provided with a plurality of lead wires 41 that are electrically conductive with the first electrodes 11 and the second electrodes 12 and that are parallel to each other. In the input device 1 according to this embodiment, each lead wire 41 extends toward the distal end from the support base member 15 along the first principal surface 51 of the extension 20, and an extension end 20E is provided with electrode pads 42. In the input device 1 according to this embodiment, the first principal surface 51 is a principal surface extending continuously to the first base principal surface S0. The lead wires 41 are composed of a conductive material. Specific configuration examples of each lead wire 41 include a layer composed of a nonmetallic conductive material (e.g., ITO), a layer composed of metal (e.g., copper (Cu) or a copper-nickel (Cu—Ni) alloy), a multilayer body constituted of a layer composed of metal (e.g., Cu) and a layer composed of an alloy (e.g., Cu—Ni alloy), and a multilayer body constituted of a layer composed of metal (e.g., Cu or Cu—Ni alloy) and a layer composed of a nonmetallic conductive material (e.g., ITO).

As shown in FIG. 1 and FIGS. 2A to 2C, the extension 20 is in a bent state when in use and has the bent section BR between the extension end 20E of the extension 20 and a connection base 20B of the extension 20 connecting to the support base member 15. Since the lead wires 41 located at the bent section BR are liable to become damaged, the input device 1 has a bend allowance section BR0 that allows bending between the extension end 20E and the connection base 20B. A detailed description about the configuration of the bend allowance section BR0 will be provided later.

The housing 3 accommodates therein the flexible wiring substrate 8 to be joined to the extension 20. The substrate of the flexible wiring substrate 8 is formed of, for example, a polyimide film. The flexible wiring substrate 8 has the connection terminal 8a electrically conductive with the lead wires 41 at the principal surface (second principal surface S2), and is disposed facing the first principal surface 51 of the extension 20. The housing 3 also accommodates therein the display device 7, such as a liquid crystal display panel or an electroluminescence display panel. A display image on the display device 7 is viewable from the outside (the operation surface OS side) through the support base member 15 and the panel 3b.

The lead wires 41 are electrically conductive with the connection terminal 8a at the extension end 20E side of the extension 20 relative to the bend allowance section BR0, specifically, at the electrode pads 42 provided at the ends located at the extension end 20E side of the lead wires 41. As shown in FIG. 2B, the electrode pads 42 and the connection terminal 8a are electrically conductive with each other via a conductive joining member 61. In detail, the conductive joining member 61 may be composed of a pressure-cured product of an anisotropic conductive adhesive. With regard to this pressure-cured product, the anisotropic conductive adhesive is cured while being pressed between the electrode pads 42 and the connection terminal 8a. The anisotropic conductivity is achieved in the pressing direction, that is, in the X1-X2 direction in FIG. 2B. The end at the extension end 20E side of the bend allowance section BR0 (the end at the X2 side in the X1-X2 direction in FIG. 2C) serves as a connection section with the electrode pads 42 of the lead wires 41.

A segment of the lead wires 41 located in the bend allowance section BR0 (this segment is also referred to as “bend lead wires 41B” in this specification) is entirely provided with a cover 70. In the input device 1 according to this embodiment, the flexible wiring substrate 8 may have an extension substrate section 8E extending toward the connection base 20B and serving as a part of the cover 70. The end at the connection base 20B side of the bend allowance section BR0 (the end at the X1 side in the X1-X2 direction in FIG. 2C) serves as the distal end of the extension substrate section 8E (the end at the connection base 20B side).

At the principal surface S2 facing the first principal surface 51 of the extension substrate section 8E, a joining member (anisotropic conductive adhesive) for forming the conductive joining member 61 extends to a position above the bend allowance section BR0, and entirely covers the bend lead wires 41B. This joining member is cured with a pressure lower than that for forming the conductive joining member 61 or with no pressure, and adheres to the bend lead wires 41B as a nonconductive cured product 62 having no anisotropic conductivity, so as to serve as a part of the cover 70. Accordingly, the cover 70 having a multilayer structure constituted of the extension substrate section 8E and the nonconductive cured product 62 is provided entirely on the bend lead wires 41B.

As shown in FIG. 2B, a specific example of an anisotropic conductive adhesive has conductive particles (nickel (Ni) particles with a diameter of about 5 μm as a specific example) dispersed in a curable resin-based material. By being cured while receiving pressure, a cured product (conductive joining member 61) with increased conductivity specifically in the thickness direction is obtained. In contrast, when cured while receiving no pressure or low pressure, a nonconductive cured product (nonconductive cured product 62) with no particular conductivity is obtained. Therefore, even though the nonconductive cured product 62 is directly provided as a part of the cover 70 on the bend lead wires 41B, a short circuit does not occur between the wires.

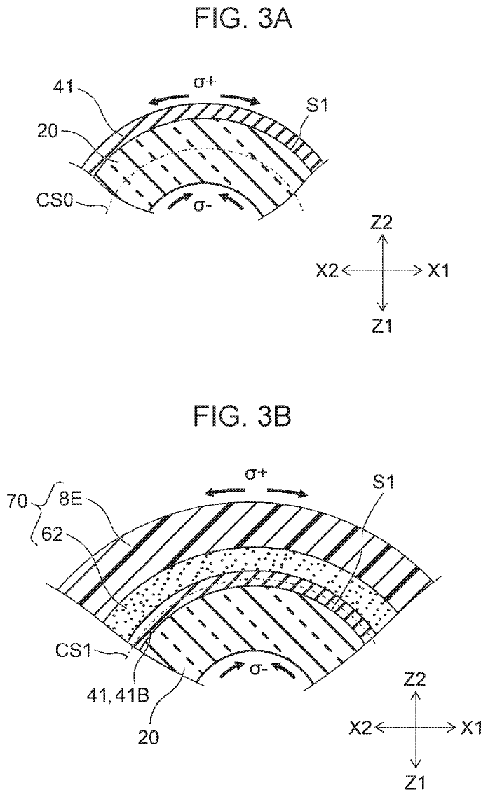

Even when the bend allowance section BR0 is partially or entirely bent (a bent part of the bend allowance section BR0 serves as the bent section BR in FIG. 1 or FIGS. 2A to 2C), the cover 70 is provided entirely on the bend lead wires 41B, so that a crack in the bend lead wires 41B due to tensile stress caused by bending is suppressed. This will be described in detail with reference to FIGS. 3A and 3B.

FIG. 3A is a partial cross-sectional view illustrating the state of a bent section BR in an input device according to a related art. FIG. 3B is a partial cross-sectional view illustrating the state of the bent section BR in the input device 1 according to the first embodiment. As shown in FIG. 3A, in a multilayer configuration of the extension 20 and the lead wires 41, the extension 20 normally has a thickness of several tens of μm, whereas the lead wires 41 normally have a thickness of 1 μm or smaller. Therefore, a neutral plane CS0 in the thickness direction is located inside the extension 20. A compressive stress σ− occurs at the inner side of the neutral plane CS0, whereas a tensile stress σ+ occurs at the outer side of the neutral plane CS0. At the neutral plane CS0, the stresses in the in-plane direction are canceled out.

In the configuration shown in FIG. 3A, the lead wires 41 are located at the outermost side distant from the neutral plane CS0, so that a high tensile stress σ+ occurs at the lead wires 41. Thus, the lead wires 41 are liable to become damaged by being bent. Furthermore, as mentioned above, since the neutral plane CS0 is located inside the extension 20, a stress variation is liable to increase in the thickness direction of the material forming the extension 20. Thus, if the extension 20 is formed of a film containing a cycloolefin-based polymer, it may be not possible for the film to bear this stress variation, possibly leading to problems, such as a crack.

In contrast, in the input device 1 according to the first embodiment, the lead wires 41 (bend lead wires 41B) in the bend allowance section BR0 that are provided on the first principal surface S1 of the extension 20 are covered by the multilayer structure constituted of the extension substrate section 8E and the nonconductive cured product 62, as shown in FIG. 3B. Therefore, a neutral plane CS1 in the thickness direction is located inside the bend lead wires 41B. Consequently, even when the extension 20 is bent, a high tensile stress σ+ does not occur at the bend lead wires 41B, so that the bend lead wires 41B are less liable to become damaged.

Furthermore, in the configuration shown in FIG. 3B, the extension 20 is entirely located at the inner side of the neutral plane CS1, so that only a compressive stress σ− occurs at the extension 20. Thus, a stress variation in the thickness direction of the material forming the extension 20 is smaller than in the configuration shown in FIG. 3A. Consequently, even though the extension 20 is formed of a film containing a cycloolefin-based polymer, problems, such as a crack, are less likely to occur.

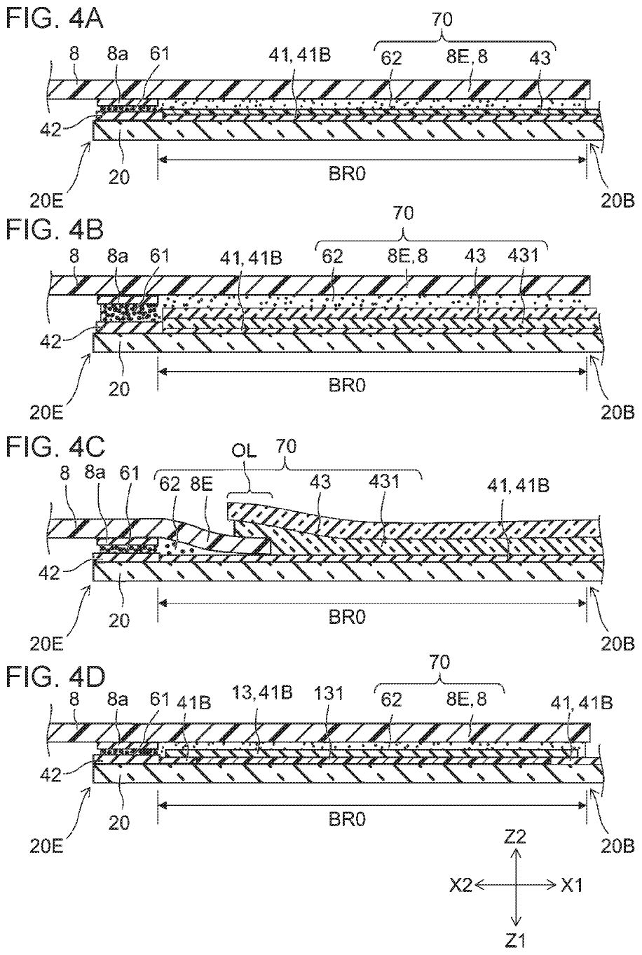

The cover 70 in the input device 1 shown in FIG. 1 and FIGS. 2A to 2C is constituted of the extension substrate section 8E and the nonconductive cured product 62, but is not limited to this configuration. The cover 70 may be formed of the nonconductive cured product 62, or the cover 70 may be formed of a cured product of a normal adhesive material instead of an anisotropic conductive adhesive. Other examples will be described with reference to FIGS. 4A to 4D.

FIG. 4A illustrates the configuration of the extension 20, in a yet-to-be bent state, and components attached thereto (also referred to as “extension and so on” in this specification) in another example of the input device 1 according to the first embodiment. FIG. 4B illustrates the configuration of the extension and so on according to yet another example of the input device 1 according to the first embodiment. In each of FIGS. 4A to 4D, the transparent adhesive layer 5, the panel 3b, and so on provided above the support base member 15 are not shown.

Although the basic configuration of the extension and so on shown in FIG. 4A and FIG. 4B is the same as that of the extension and so on in the input device 1 shown in FIG. 1 and FIGS. 2A to 2C, the extension and so on shown in FIG. 4A and FIG. 4B are different therefrom in that a functional layer 43 extending over the extension 20 from the sensor unit 10 side may serve as a part of the cover 70. Specific examples of the functional layer 43 include a protection layer for preventing the routing pattern 150 and the lead wires 41 from corrosion and so on, a protection layer for protecting the first electrodes 11 and the second electrodes 12 from corrosion and so on, and an optical layer, such as a polarizing plate, located between the sensor unit 10 and the panel 3b. The functional layer 43 may have a multilayer structure constituted of these plurality of layers.

In the example shown in FIG. 4A, the cover 70 is constituted of the functional layer 43 formed of a protection layer located on the bend lead wires 41B, the nonconductive cured product 62, and the extension substrate section 8E. In the example shown in FIG. 4B, the cover 70 is constituted of the functional layer 43 formed of an optical layer located on the bend lead wires 41B, the nonconductive cured product 62, and the extension substrate section 8E. The optical layer serving as the functional layer 43 may have a layer for fixing itself to another layer, or may additionally be provided with an adhesive layer 431, as in the example shown in FIG. 4B. In the example shown in FIG. 4B, the functional layer 43 formed of the optical layer is bonded to the bend lead wires 41B by the adhesive layer 431 formed of a transparent adhesive.

Accordingly, the cover 70 is constituted of a multilayer body including the functional layer 43, the nonconductive cured product 62, and the extension substrate section 8E, so that the bend lead wires 41B that are liable to become damaged when bent can be readily positioned near the neutral plane CS1 in the thickness direction or at the inner side of the neutral plane CS1. Therefore, even when the bend allowance section BR0 is bent such that the extension 20 is located at the inner side, the extension substrate section 8E is located at the outermost side where the tensile stress σ+ is at a maximum, so that problems, such as breakage of the bend lead wires 41B, are less likely to occur.

FIG. 4C illustrates the configuration of a modification of the extension and so on shown in FIG. 4B. As shown in FIG. 4C, in the configuration according to this example, the bend allowance section BR0 has a plurality of different structures in the extending direction (X1-X2 direction) of the extension 20. At the extension end 20E side (the X2 side in the X1-X2 direction), the cover 70 located on the bend lead wires 41B is constituted of the nonconductive cured product 62 and the extension substrate section 8E. At the connection base 20B side (the X1 side in the X1-X2 direction), the cover 70 located on the bend lead wires 41B is constituted of the functional layer 43, formed of an optical layer, and the adhesive layer 431. The material forming the adhesive layer 431 may be a transparent adhesive or may be the material forming the nonconductive cured product 62. In FIG. 4C, a case where the adhesive layer 431 is formed of the transparent adhesive also used for the extension and so on shown in FIG. 4B is illustrated as a specific example. In an area indicated as an overlap section OL in FIG. 4C, the cover 70 is constituted of the extension substrate section 8E extending from the extension end 20E side (the X2 side in the X1-X2 direction) and the functional layer 43 and the adhesive layer 431 extending from the connection base 20B side (the X1 side in the X1-X2 direction). Accordingly, the cover 70 may have different structures in the extending direction. Even in such a case, the bend lead wires 41B may entirely be covered by the cover 70.

FIG. 4D illustrates the configuration of the extension and so on according to yet another example of the input device according to the first embodiment. In the configuration shown in FIG. 4D, at least a part of the bend lead wires 41B located at the bend allowance section BR0 is formed of a flexible conductive member 13 instead of a material forming the routing pattern 150. As a specific example, the flexible conductive member 13 is formed of a multilayer body including a first amorphous ITO layer, a conductive layer, and a second amorphous ITO layer, as indicated in International Publication No. WO 2017/195451. In FIG. 4D, the flexible conductive member 13 lies over the bend lead wires 41B electrically conductive with the electrode pads 42 at the extension end 20E side (the X2 side in the X1-X2 direction) so as to be electrically connected to the bend lead wires 41B, and lies over the bend lead wires 41B electrically conductive with the routing pattern 150 at the connection base 20B side (the X1 side in the X1-X2 direction) (i.e., the section located at the X1 side in the X1-X2 direction relative to the bend allowance section BR0 serves as the lead wires 41) so as to be electrically connected to the bend lead wires 41B.

Furthermore, in a case where an intersection where the plurality of electrode units (first electrodes 11 and second electrodes 12) located in the sensor unit 10 are electrically insulated from each other while intersecting each other is provided and this intersection is also formed of the aforementioned flexible conductive member 13, such a case is preferable since the flexible conductive member 13 located at the bend lead wires 41B can be formed in accordance with a manufacturing process for forming the sensor unit 10 having the plurality of electrode units (first electrodes 11 and second electrodes 12). If the flexible conductive member 13 is to be formed by a process similar to that for the intersection in this manner, the flexible conductive member 13 may sometimes be formed after an insulation layer 131 is formed on the first principal surface S1 of the extension end 20E, as shown in FIG. 4D. In this case, the insulation layer 131 has a function of keeping the flexible conductive member 13 serving as the bend lead wires 41B away from the neutral plane in the thickness direction of the bend allowance section BR0.

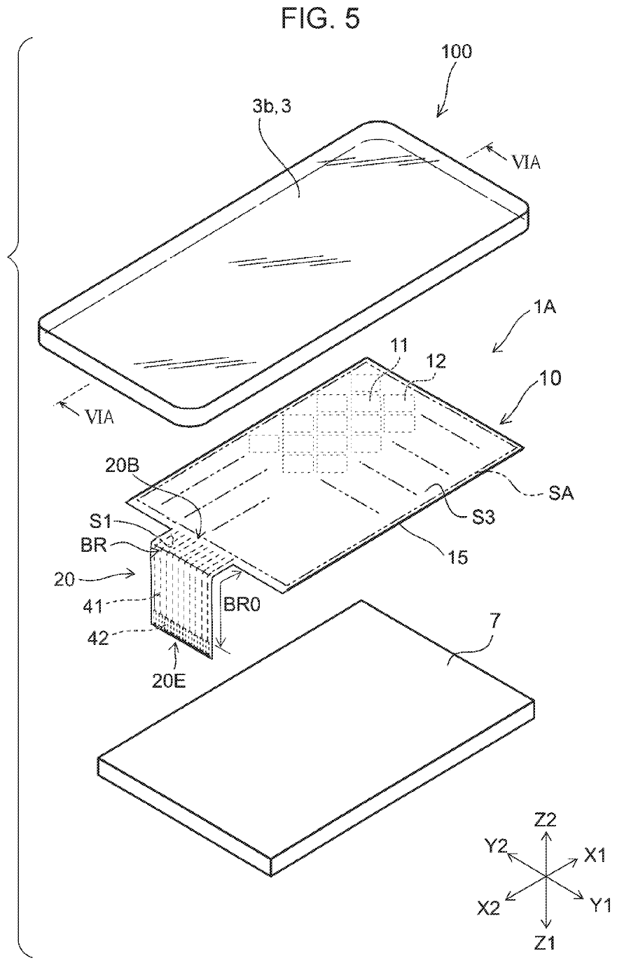

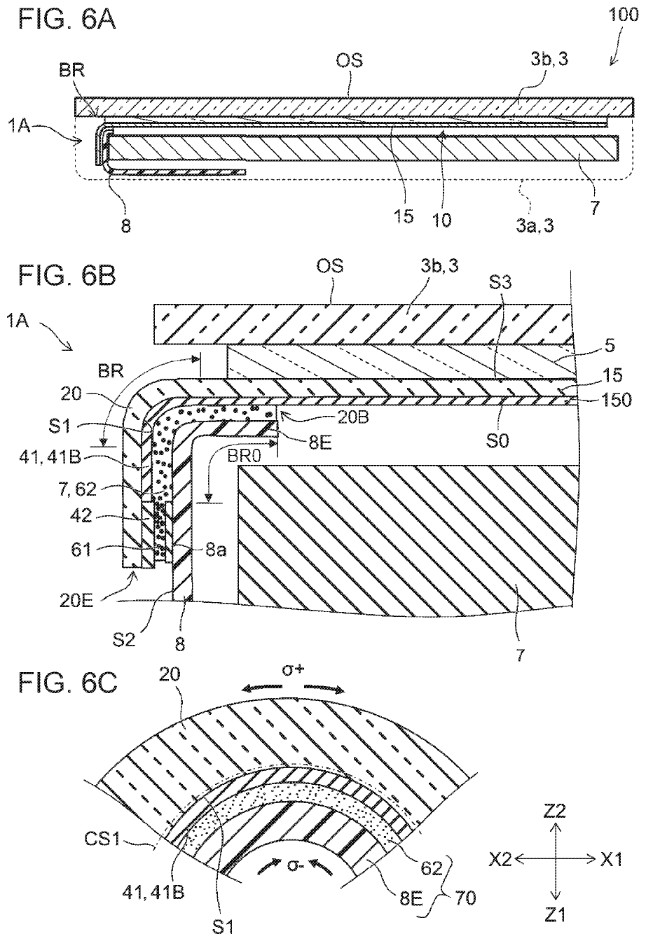

FIG. 5 is an exploded perspective view illustrating an interface apparatus to which an input device according to a second embodiment of the present invention is applied. FIG. 6A is a cross-sectional view taken along line VIA-VIA in FIG. 5. FIG. 6B is an enlarged partial cross-sectional view of the bent section BR and the vicinity thereof in FIG. 6A. FIG. 6C is a partial cross-sectional view illustrating the state of the bent section BR of the input device according to the second embodiment.

As shown in FIG. 5 and FIG. 6A, an input device 1A according to the second embodiment has a basic configuration identical to that of the input device 1 according to the first embodiment shown in FIG. 1, FIGS. 2A to 2C, and so on, but has a different layout in the interface apparatus 100. In detail, in the input device 1 according to the first embodiment, the first base principal surface S0 located at the same side as the first principal surface 51 of the extension 20 is disposed at the operation surface OS side (the Z2 side in the Z1-Z2 direction). In contrast, in the input device 1A according to the second embodiment, a second base principal surface S3 serving as a principal surface opposite the first base principal surface is disposed at the operation surface OS side (the Z2 side in the Z1-Z2 direction).

Therefore, as shown in FIG. 6B, in the bent section BR of the input device 1A according to the second embodiment, the extension 20 is bent such that the extension 20 is located at the outer side and the extension substrate section 8E is located at the inner side. In a case where the extension 20 is bent in this manner, the bend lead wires 41B are located at the inner side of the neutral plane CS1, as shown in FIG. 6C, even if the neutral plane CS1 is located inside the extension 20 due to the extension 20 being relatively thick and the extension substrate section 8E being relatively thin. Thus, stress occurring at the bend lead wires 41B due to the bending is compressive (compressive stress σ−), so that problems, such as a crack, are less likely to occur at the bend lead wires 41B.

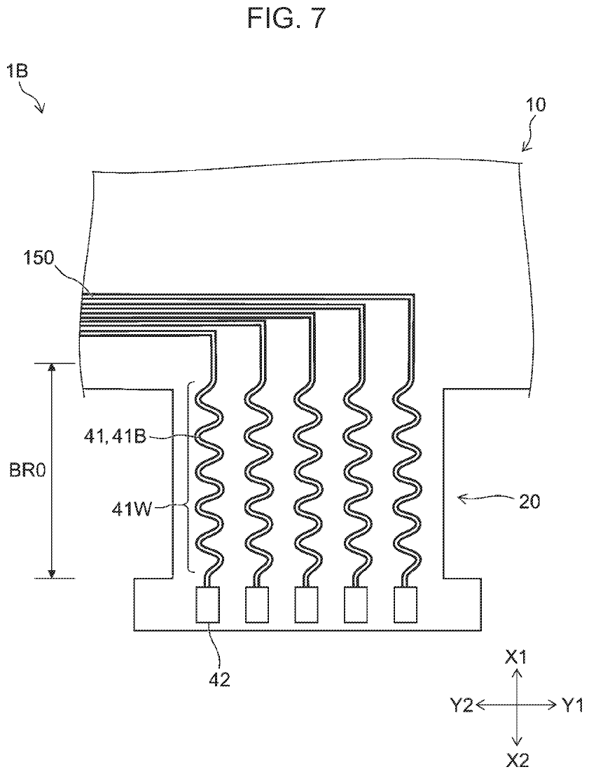

FIG. 7 illustrates the configuration of an extension and so on according to an input device 1B according to a third embodiment of the present invention. For providing an easier understanding, only the sensor unit 10, the routing pattern 150, the extension 20, and the lead wires 41 (including the bend lead wires 41B and the electrode pads 42) are shown in FIG. 7.

The basic configuration of the extension and so on of the input device 1B shown in FIG. 7 is the same as that of the extension and so on in the input device 1 shown in FIG. 4C, but is different therefrom in that the bend lead wires 41B may each have a meandering section 41W when viewed from the normal direction (Z1-Z2 direction) of the first principal surface S1. The meandering section 41W has segments in which the bend lead wire 41B is inclined toward the X1 side in the X1-X2 direction from the Y1-Y2 direction within an X-Y plane on the extension 20 and segments in which the bend lead wire 41B is inclined toward the X2 side in the X1-X2 direction from the Y1-Y2 direction. Even when the first principal surface S1 of the extension 20 is bent such that a tensile stress σ+ occurs at the bend lead wires 41B, the tensile stress σ+ applied to the bend lead wires 41B attenuates in accordance with the inclination of the meandering sections 41W relative to the extending direction (Y1-Y2 direction) of the extension 20. Therefore, even if the extension 20 is bent by a large degree, problems, such as a crack, are less likely to occur at the bend lead wires 41B. Accordingly, since the bend lead wires 41B of the input device 1B are durable against bending, the input device 1B may be disposed in the interface apparatus 100 such that the first base principal surface S0 is located at the operation surface OS side or the second base principal surface S3 is located at the operation surface OS side.

### Application Example

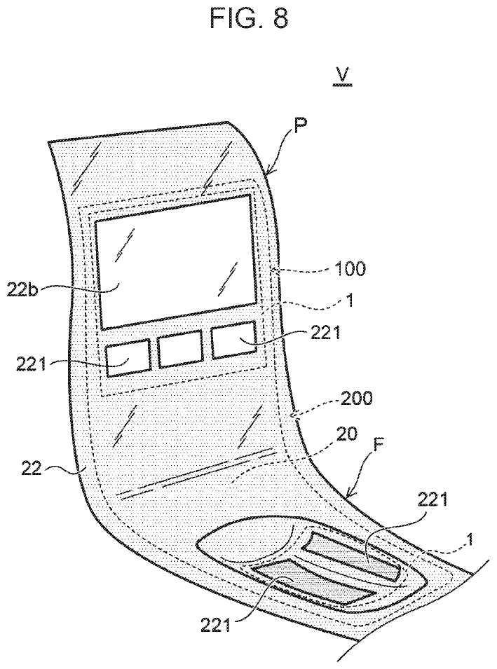

FIG. 8 schematically illustrates an application example of the input device 1, 1A, or 1B according to an embodiment of the present invention. In the example shown in FIG. 8, the input device 1 according to this embodiment is applied to each of an instrument panel P and a floor console F of a moving body V, such as a vehicle. In the example shown in FIG. 8, the interface apparatus 100 is disposed to extend continuously between the instrument panel P and the floor console F, and the instrument panel P and the floor console F are each provided with the input device 1.

For example, the instrument panel P has an area (non-formation region 22b) where a decorative layer 22 of a decorative film 200 is not provided, and the detection region SA of the input device 1 is provided to include the non-formation region 22b, thereby functioning as a touchscreen. The instrument panel P and the floor console F may be provided with a button display unit 221 by the decorative layer 22. Accordingly, various types of operations can be performed by touching the button display unit 221 of the decorative layer 22.

The detection region SA of the input device 1 may be split into the area of the instrument panel P and the area of the floor console F, as described above, or may be provided to extend continuously from the instrument panel P to the floor console F.

As described above, the embodiment can provide an input device 1 that can suppress damage to the bend lead wires 41B provided in the extension 20 even when the extension 20 is bent.

Although the embodiments have been described above, the present invention is not limited to these examples. For example, the extension 20 has a width smaller than the width of the support base member 15 in the above example, but may have the same width as the support base member 15. An embodiment in which one or more components are appropriately added to, deleted from, or changed in design in each of the above embodiments by a skilled person or an embodiment obtained by appropriately combining the features of the embodiments is included in the scope of the present invention so long as the embodiment includes the gist of the present invention. For example, the panel 3b may be a part of the input device 1. In this case, the panel 3b is disposed facing the first base principal surface S0 of the support base member 15 in a configuration corresponding to the first embodiment, and the panel 3b is disposed facing the second base principal surface S3 of the support base member 15 in a configuration corresponding to the second embodiment.

### EXAMPLES

Although the present invention will be described below in further detail with reference to examples, the scope of the present invention is not to be limited to these examples.

### Example 1

The input device 1 prepared includes the extension and so on having the multilayer structure shown in Table 1 in the thickness direction (toward the Z2 side in the Z1-Z2 direction) from the extension 20 side. The details of the layers constituting the extension and so on are as follows. The first protection layer, the second protection layer, the nonconductive cured product 62, and the extension substrate section 8E shown in Table 1 may be the components of the cover 70.
Extension 20: A cycloolefin polymer film with a thickness of 43 μm
One Type of Bend Lead Wires 41B (First Connection Material): A multilayer conductor with a thickness of 178 nm (a multilayer body constituted of an ITO layer with a thickness of 28 nm, a CuNi alloy layer with a thickness of 15 nm, a Cu layer with a thickness of 120 nm, and a CuNi alloy layer with a thickness of 15 nm)
One Type of Bend Lead Wires 41B (Second Connection Material): A flexible conductive member with a thickness of 45 nm (a multilayer body constituted of an amorphous ITO layer with a thickness of 15 nm, an Au layer with a thickness of 15 nm, and an amorphous ITO layer with a thickness of 15 nm)
One Type of Functional Layer 43 as Protection Layer (First Protection Layer): A resist cured layer (acrylic resin) with a thickness of 1.5 μm for protecting the routing pattern 150
Another Type of Functional Layer 43 as Protection Layer (Second Protection Layer): A dry film resist cured layer (acrylic resin) with a thickness of 8 μm for protecting components located in the detection region SA
Nonconductive Cured Product 62: A cured layer (acrylic resin) with a thickness of 10 μm obtained by curing an anisotropic conductive adhesive (acrylic resin) having Ni balls with a diameter of about 10 μm dispersed therein while applying a relatively low pressure thereto
Extension Substrate Section 8E: A polyimide film with a thickness of 12.5 μm

TABLE 1

| Sample Number | 1 | 2 | 3 | 4 | 5 | 6 |
|---|---|---|---|---|---|---|
| Extension | Present | Present | Present | Present | Present | Present |
| Bend Lead Wires | First | First | First | Second | Second | Second |
| | Connection | Connection | Connection | Connection | Connection | Connection |
| | Material | Material | Material | Material | Material | Material |
| Pattern | Meandering | Meandering | Straight | Straight | Meandering | Straight |
| First Protection | Present | Absent | Absent | Present | Present | Present |
| Layer | | | | | | |
| Second Protection | Present | Absent | Present | Absent | Absent | Present |
| Layer | | | | | | |
| Nonconductive | Present | Present | Present | Absent | Present | Present |
| Cured Product | | | | | | |
| Extension | Present | Present | Present | Absent | Present | Present |
| Substrate Section | | | | | | |
| Total Thickness | 75.2 | 65.7 | 73.7 | 44.7 | 67.2 | 75.2 |
| (μm) | | | | | | |
| Distance from | 5.4 | 10.2 | 6.2 | 22.2 | 10.9 | 6.9 |
| Neutral Plane | | | | | | |
| (μm) | | | | | | |
| Electrical | 30 | 29 | 28 | 2 | 24 | 28 |
| Inspection Result | | | | | | |
| Remarks | Present | Present | Present | Comparative | Present | Present |
| | Invention | Invention | Invention | Example | Invention | Invention |

In the case where the bend lead wires 41B are composed of the second connection material, the first protection layer is formed as the insulation layer 131 on the first principal surface S1 of the extension 20, as in FIG. 4D, and the second connection material is formed on the first protection layer.

Table 1 also indicates whether the bend lead wires 41B are straight in the extending direction (X1-X2 direction) in plan view (in the Z1-Z2 direction) and have the meandering sections 41W.

The total thickness (unit: μm) of the extension and so on and the distance (unit: μm) between the surface at the extension 20 side of each bend lead wire 41B and the neutral plane in the configuration according to each sample number are also indicated in Table 1. With regard to the aforementioned distance, the side farther away from the extension 20 is set to have a positive value. Therefore, a higher tensile stress σ+ occurs at the bend lead wires 41B when the extension 20 is bent to be located at the inner side as the positive value of the aforementioned distance increases.

Results obtained by manufacturing 30 input devices 1 according to each sample number and performing an electrical inspection process (for checking the electrical conductivity) are indicated in Table 1. The numerical values indicated in Table 1 each correspond to the number of non-defective items as a result of the electrical inspection process. This implies that defects in the bend lead wires 41B are less likely to occur as the numerical value approaches 30.

As indicated in Table 1, a favorable electrical inspection result was obtained as the distance from the neutral plane was a smaller positive value. This trend was confirmed regardless of the material forming the bend lead wires 41B. In each of the input devices 1 according to sample number 4 to sample number 6, the first protection layer is located between the second connection material and the extension 20, as described above, and thus does not function as the cover 70. Therefore, the input device 1 according to sample number 4 is in a state where the cover 70 is absent, resulting in a large number of defective items. With regard to the input device 1 according to sample number 5, the cover 70 is constituted of the nonconductive cured product 62 and the extension substrate section 8E, and the bend lead wires 41B are each formed of the flexible conductive member 13 and each have a meandering section. However, the number of defective items is larger than that of the input device 1 according to sample number 2 in which the bend lead wires 41B are composed of the first connection material having relatively low flexibility. In the input device 1 according to sample number 4, the first protection layer is located between the second connection material and the extension 20, and there is a possibility of an effect of an increase in the distance between the bend lead wires 41B and the neutral plane.

### Example 2

With regard to each of the input devices 1 according to sample numbers 1 to 3, 5, and 6 from which favorable results were obtained in Example 1, the flex resistance thereof was evaluated by using a mandrel with a diameter of 1 mm (radius R: 0.5 mm) based on the cylindrical mandrel method regulated by JIS K 5600-5-5:1999. With regard to the bending direction, bending was performed in the direction based on the first embodiment (the extension 20 was bent so as to be located at the inner side, also referred to as “up-facing version” hereinafter), and bending was performed in the direction based on the second embodiment (the extension 20 was bent so as to be located at the outer side, also referred to as “down-facing version” hereinafter). The evaluation was performed on the input device 1 according to each sample number based on two standards (N=2). However, the evaluation performed on the up-facing version of the input device 1 according to sample number 1 was based on one standard. Table 2 indicates results obtained from the up-facing version, and Table 3 indicates results obtained from the down-facing version. In Table 2 and Table 3, “A” indicates that there were no cracks in the bend lead wires 41B in the evaluation after a bend test, and “B” indicates that there was a crack in the bend lead wires 41B in the evaluation after a bend test. In each bend test, the bend test was terminated when a crack formed in the bend lead wires 41B.

TABLE 2

| Sample | Test | Bent | Bent | Bent | Bent |
|---|---|---|---|---|---|
| Number | Number | Once | 3 Times | 5 Times | 10 Times |
| 1 | 1 | A | A | A | A |
| 2 | 1 | A | A | A | A |
| | 2 | A | A | A | A |
| 3 | 1 | A | A | B | |
| | 2 | A | A | A | A |
| 5 | 1 | B | | | |
| | 2 | B | | | |
| 6 | 1 | B | | | |
| | 2 | B | | | |

TABLE 3

| Sample | Test | Bent | Bent | Bent | Bent |
|---|---|---|---|---|---|
| Number | Number | Once | 3 Times | 5 Times | 10 Times |
| 1 | 1 | A | A | A | A |
| | 2 | A | A | A | A |
| 2 | 1 | A | A | A | B |
| | 2 | A | A | A | A |
| 3 | 1 | A | A | A | A |
| | 2 | A | A | A | A |
| 5 | 1 | A | A | B | |
| | 2 | A | A | A | A |
| 6 | 1 | A | A | A | A |
| | 2 | A | A | A | A |

As indicated in Table 2, with the up-facing version, when the bend lead wires 41B are composed of the second connection material (the input devices 1 according to sample number 5 and sample number 6), there was a crack in the bend lead wires 41B after being bent once. In contrast, as indicated in Table 3, with the down-facing version, the bend lead wires 41B had no cracks therein after being bent up to three times even when the bend lead wires 41B are composed of the second connection material. Therefore, it was confirmed that the up-facing version has a stricter bending condition than the down-facing version.

Even with the up-facing version, if the bend lead wires 41B are composed of the first connection material (the input devices 1 according to sample 1 to sample 3), the bend lead wires 41B had no cracks therein after being bent up to three times. This indicates that the first connection material is the more preferable material for forming the bend lead wires 41B.

Furthermore, in the case where the bend lead wires 41B are composed of the first connection material and have the meandering sections 41W (the input devices 1 according to sample number 1 and sample number 2), the bend lead wires 41B had no cracks therein after being bent 10 times. This indicates that the bend lead wires 41B preferably have the meandering sections 41W.

What is claimed is:

1. An input device comprising:
a support base member;
a sensor unit provided on the support base member and having a plurality of electrode units;
an extension extending outward from the support base member;
a lead wire provided along a first principal surface of the extension and electrically conductive with the plurality of electrode units; and
a flexible wiring substrate having a connection terminal electrically conductive with the lead wire in a principal surface and disposed facing the first principal surface of the extension,
wherein the extension has a bend allowance section that allows bending between an extension end and a connection base connected to the support base member,
wherein the lead wire is electrically conductive with the connection terminal at the extension-end side of the extension relative to the bend allowance section, and
wherein a cover is provided entirely over the lead wire located at the bend allowance section.

2. The input device according to claim 1,
wherein the lead wire and the connection terminal are joined in an electrically conductive manner by a conductive joining member, wherein a joining member for forming the conductive joining member extends over the bend allowance section, and wherein a member based on the joining member serves as at least a part of the cover.

3. The input device according to claim 2, wherein the conductive joining member is formed of a cured product of an anisotropic conductive adhesive.

4. The input device according to claim 1, wherein the flexible wiring substrate has an extension substrate section extending toward the sensor unit relative to the connection terminal, and wherein the extension substrate section serves as a part of the cover.

5. The input device according to claim 1, further comprising a functional layer provided on the support base member, wherein the functional layer extends over the bend allowance section and serves as a part of the cover.

6. The input device according to claim 5, wherein the functional layer includes a protection layer protecting the sensor unit.

7. The input device according to claim 5, wherein the functional layer includes an optical layer.

8. The input device according to claim 1, wherein the lead wire located at the bend allowance section has a meandering section that meanders, as viewed from a normal direction of the first principal surface.

9. The input device according to claim 1, wherein the support base member and the extension are composed of a translucent material containing a cycloolefin-based polymer.

10. The input device according to claim 1, wherein the plurality of electrode units and the lead wire are electrically connected by a routing pattern provided on the support base member, and wherein the lead wire located at the bend allowance section is composed of a material forming the routing pattern.

11. The input device according to claim 1, wherein, in the support base member, a second base principal surface located opposite the first principal surface of the extension is located at an operation-surface side of the input device.

12. The input device according to claim 11, further comprising a panel disposed facing the second base principal surface.
